(19) United States
(12) Patent Application Publication
(10) Pub. No.: US 2002/0128826 A1
(43) Pub. Date: Sep. 12, 2002

(54) Speech recognition system and method, and information processing apparatus and method used in that system

(76) Inventors: Tetsuo Kosaka, Kanagawa (JP); Hiroki Yamamoto, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/086,740

(22) Filed: Mar. 4, 2002

(30) Foreign Application Priority Data
Mar. 8, 2001 (JP) 2001-065383

(51) Int. Cl. G10L 19/14; G06F 17/20

(52) U.S. Cl. 704/211; 704/1

(57) ABSTRACT

In a terminal, acoustic information input by an acoustic input unit is analyzed by an acoustic processor to acquire multi-dimensional feature quantity parameters. In an initial setup process, a speech communication information generator on the terminal generates a processing condition (clustering result table) for compression-encoding on the basis of the multi-dimensional feature quantity parameters, and stores the condition in speech communication information holding units of the terminal and a server. In a speech recognition process, the terminal encodes acoustic information using the processing condition, and sends encoded data to the server. The server decodes the encoded data using the processing condition, and executes speech recognition. In this way, appropriate encoding can be achieved in accordance with a change in acoustic feature, and the recognition rate and compression ratio upon encoding can be prevented from lowering due to a change in environmental noise.

### FIELD OF THE INVENTION

This invention relates to a speech recognition system, apparatus, and their methods.

### BACKGROUND OF THE INVENTION

In recent years, along with the advance of the speech recognition technique, attempts have been made to use such technique as an input interface of a device. When the speech recognition technique is used as an input interface, it is a common practice to introduce an arrangement for a speech process in the device, to execute speech recognition in that device, and to handle the speech recognition result as input operation to the device.

On the other hand, recent development of compact portable terminals allows compact portable terminals to implement many processes. However, such compact portable terminal cannot comprise sufficient input keys due to its size limitation. For this reason, a demand has arisen for using the speech recognition technique for operation instructions that implement various functions.

As one implementation method, a speech recognition engine is installed in the compact portable terminal itself. However, such compact portable terminal has limited resources such as a memory, CPU, and the like, and cannot be often installed with a high-performance recognition engine. Hence, a client-server speech recognition system has been proposed. In this system, a compact portable terminal is connected to a server via, e.g., a wireless network, a process that requires low processing cost of the speech recognition process is executed on the terminal, and a process that requires a large processing volume is executed on the server.

In this case, since the data size to be transferred from the terminal to the server is preferably small, it is a common practice to compress (encode) data upon transfer. As for the encoding method for this purpose, an encoding method suitable for sending data associated with speech recognition has been proposed in place of a general audio encoding method used in a portable telephone.

Encoding suitable for speech recognition, which is used in the aforementioned client-server speech recognition system adopts a method of calculating feature parameters of speech, and then encoding these parameters by scalar quantization, vector quantization, or subband quantization. In such case, encoding is done without considering any acoustic feature upon speech recognition.

However, when speech recognition is used in a noisy environment, or when the characteristics of a microphone used in speech recognition are different from general ones, an optimal encoding process differs. For example, in case of the above method, since the distribution of feature parameters of speech in a noisy environment is different from that of feature parameters of speech in a silent environment, it is preferable to adaptively change the quantization range accordingly.

Since the conventional method encodes without considering a change in acoustic feature, the recognition rate deteriorates, and a high compression ratio cannot be set upon encoding in, e.g., a noisy environment.

### SUMMARY OF THE INVENTION

The present invention has been made in consideration of the above problems, and has as its object to achieve appropriate encoding in correspondence with a change in acoustic feature, and prevent the recognition rate and compression ratio upon encoding from lowering due to a change in environmental noise.

According to one aspect of the present invention, the forgoing object is attained by providing a speech recognition system comprising: input means for inputting acoustic information; analysis means for analyzing the acoustic information input by the input means to acquire feature quantity parameters; first holding means for obtaining and holding processing information for encoding on the basis of the feature quantity parameters obtained by the analysis means; second holding means for holding processing information for a speech recognition process in accordance with the processing information for encoding; conversion means for compression-encoding the feature quantity parameters obtained via the input means and the analysis means on the basis of the processing information for encoding; and recognition means for executing speech recognition on the basis of the processing information for speech recognition held by the holding means, and the feature quantity parameters compression-encoded by the conversion means.

According to a preferred aspect of the present invention, the forgoing object is attained by providing a speech recognition method comprising: the input step of inputting acoustic information; the analysis step of analyzing the acoustic information input in the input step to acquire feature quantity parameters; the first holding step of obtaining processing information for encoding on the basis of the feature quantity parameters obtained in the analysis step, and storing the information in first storage means; the second holding step of holding, in second storage means, processing information for a speech recognition process in accordance with the processing information for encoding; the conversion step of compression-encoding the feature quantity parameters obtained via the input step and the analysis step on the basis of the processing information for encoding; and the recognition step of executing speech recognition on the basis of the processing information for speech recognition held in the second storage means in the second holding step, and the feature quantity parameters compression-encoded in the conversion step.

According to another preferred aspect of the present invention, the forgoing object is attained by providing an information processing apparatus comprising: input means for inputting acoustic information; analysis means for analyzing the acoustic information input by the input means to acquire feature quantity parameters; holding means for generating and holding processing information for compression-encoding on the basis of the feature quantity parameters obtained by the analysis means; first communication means for sending the processing information generated by the holding means to an external apparatus; conversion means for compression-encoding the feature quantity parameters of the acoustic information obtained via the input means and the analysis means on the basis of the processing information; and second communication means for sending data obtained by the conversion means to the external apparatus.

According to still another preferred aspect of the present invention, the forgoing object is attained by providing an information processing apparatus comprising: first reception means for receiving processing information associated with compression-encoding from an external apparatus; holding means for holding, in a memory, processing information for speech recognition obtained on the basis of the processing information received by the first reception means; second reception means for receiving compression-encoded data from the external apparatus; and recognition means for executing speech recognition of the data received by the second reception means using the processing information held in the holding means.

According to still another preferred aspect of the present invention, the forgoing object is attained by providing an information processing method comprising: the input step of inputting acoustic information; the analysis step of analyzing the acoustic information input in the input step to acquire feature quantity parameters; the holding step of generating and holding processing information for compression-encoding on the basis of the feature quantity parameters obtained in the analysis step; the first communication step of sending the processing information generated in the holding step to an external apparatus; the conversion step of compression-encoding the feature quantity parameters of the acoustic information obtained via the input step and the analysis step on the basis of the processing information; and the second communication step of sending data obtained in the conversion step to the external apparatus.

According to still another preferred aspect of the present invention, the forgoing object is attained by providing an information processing method comprising: the first reception step of receiving processing information associated with compression-encoding from an external method; the holding step of holding, in a memory, processing information for speech recognition obtained on the basis of the processing information received in the first reception step; the second reception step of receiving compression-encoded data from the external method; and the recognition step of executing speech recognition of the data received in the second reception step using the processing information held in the holding step.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the arrangement of a speech recognition system according to the first embodiment;

FIG. 2 is a flow chart for explaining an initial setup process of the speech recognition system of the first embodiment;

FIG. 3 is a flow chart for explaining a speech recognition process of the speech recognition system of the first embodiment;

FIG. 4 is a block diagram showing the arrangement of a speech recognition system according to the second embodiment;

FIG. 5 is a flow chart for explaining an initial setup process of the speech recognition system of the second embodiment;

FIG. 6 is a flow chart for explaining a speech recognition process of the speech recognition system of the second embodiment; and

FIG. 7 shows an example of the data structure of a clustering result table in the first embodiment.

### DETAILED DESCRIPTION OF THE PREFERRED EMBODIMENTS

Preferred embodiments of the present invention will now be described in detail in accordance with the accompanying drawings.

<First Embodiment>

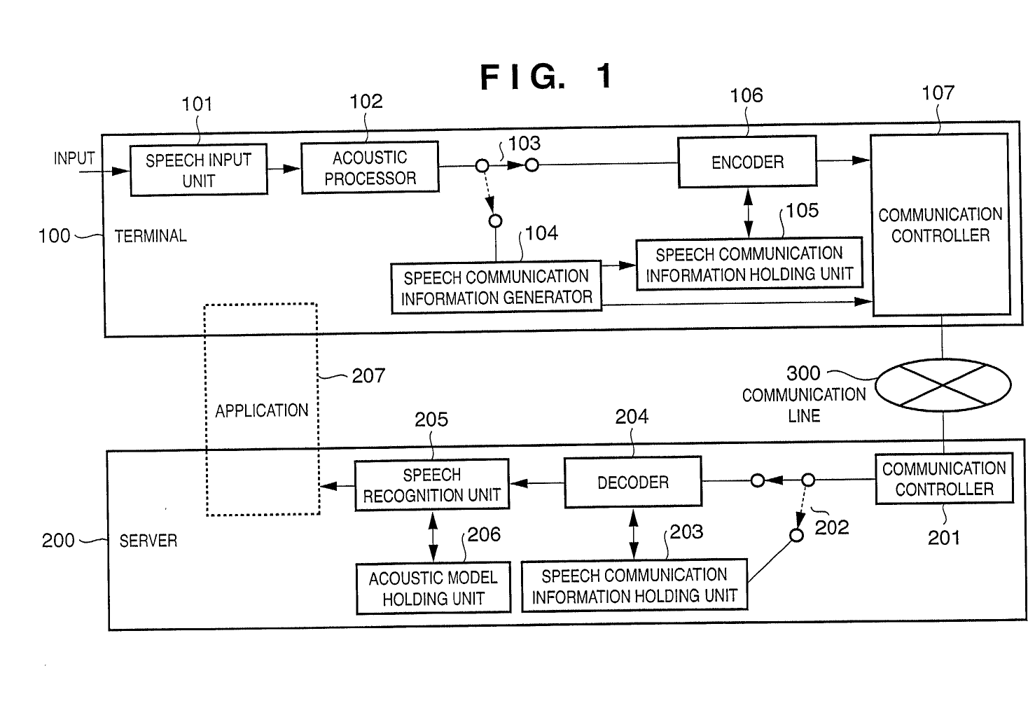

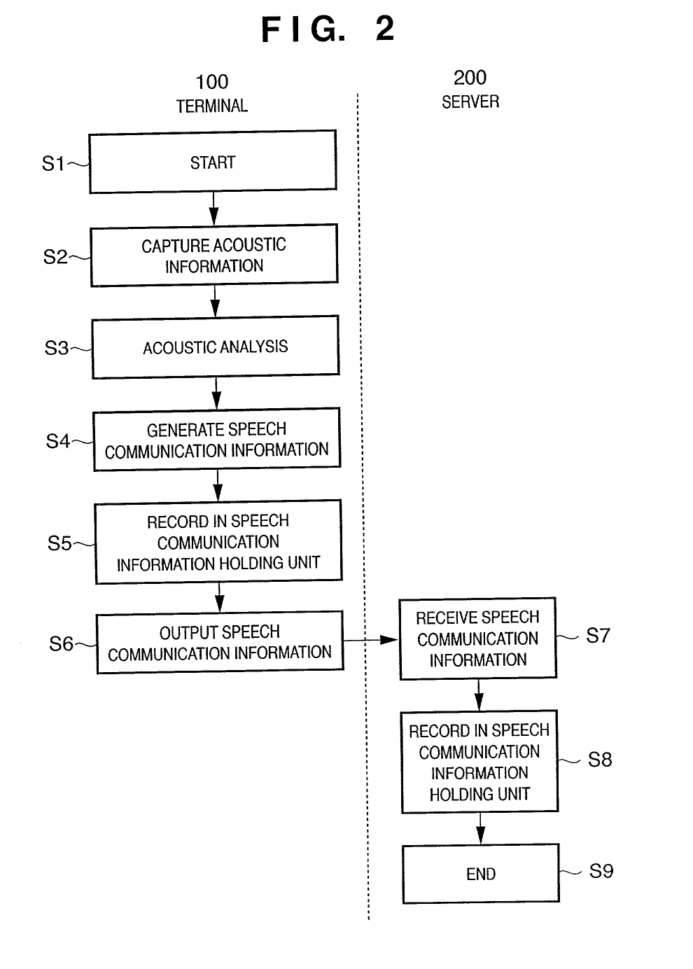

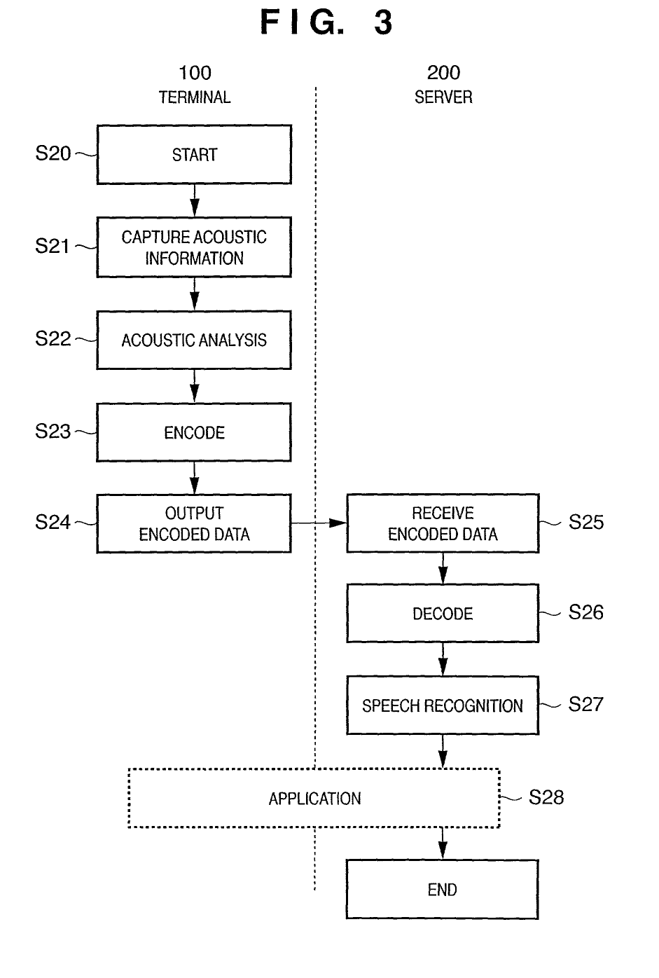

FIG. 1 is a block diagram showing the arrangement of a speech recognition system according to the first embodiment. FIGS. 2 and 3 are flow charts for explaining the operation of the speech recognition system shown in the diagram of FIG. 1. The first embodiment will be explained below as well as its operation example while associating FIG. 1 with FIGS. 2 and 3.

Referring to FIG. 1, reference numeral 100 denotes a terminal. As the terminal 100, various portable terminals including a portable telephone and the like can be applied. Reference numeral 101 denotes a speech input unit which captures a speech signal via a microphone or the like, and converts it into digital data. Reference numeral 102 denotes an acoustic processor for generating multi-dimensional acoustic parameters by acoustic analysis. Note that acoustic analysis can use analysis methods normally used in speech recognition such as melcepstrum, delta-melcepstrum, and the like. Reference numeral 103 denotes a process switch for switching the data flow between an initial setup process and speech recognition process, as will be described later with reference to FIGS. 2 and 3.

Reference numeral 104 denotes a speech communication information generator for generating data used to encode the acoustic parameters obtained by the acoustic processor 102. In this embodiment, the speech communication information generator 104 segments data of each dimension of the acoustic parameters into arbitrary classes (16 steps in this embodiment) by clustering, and generates a clustering result table using the results segmented by clustering. Clustering will be described later. Reference numeral 105 denotes a speech communication information holding unit for holding the clustering result table generated by the speech communication information generator 104. Note that various recording media such as a memory (e.g., a RAM), floppy disk (FD), hard disk (HD), and the like can be used to hold the clustering result table in the speech communication information holding unit 105.

Reference numeral 106 denotes an encoder for encoding the multi-dimensional acoustic parameters obtained by the acoustic processor 102 using the clustering result table recorded in the speech communication information holding unit 105. Reference numeral 107 denotes a communication controller for outputting the clustering result table, encoded acoustic parameters, and the like onto a communication line 300.

Reference numeral 200 denotes a server for making speech recognition of the encoded multi-dimensional acoustic parameters sent from the terminal 100. The server 200 can be constituted using a normal personal computer or the like.

Reference numeral 201 denotes a communication controller for receiving data sent from the communication controller 107 of the terminal 100 via the line 300. Reference numeral 202 denotes a process switch for switching the data flow between an initial setup process and speech recognition process, as will be described later with reference to FIGS. 2 and 3.

Reference numeral 203 denotes a speech communication information holding unit for holding the clustering result table received from the terminal 100. Note that various recording media such as a memory (e.g., a RAM), floppy disk (FD), hard disk (HD), and the like can be used to hold the clustering result table in the speech communication information holding unit 203.

Reference numeral 204 denotes a decoder for decoding the encoded data (multi-dimensional acoustic parameters) received from the terminal 100 by the communication controller 201 by looking up the clustering result table held in the speech communication information holding unit 203. Reference numeral 205 denotes a speech recognition unit for executing a recognition process of the multi-dimensional acoustic parameters obtained by the decoder 204 using an acoustic model held in an acoustic model holding unit 206.

Reference numeral 207 denotes an application for executing various processes on the basis of the speech recognition result. The application 207 may run on either the server 200 or terminal 100. When the application runs on the terminal 100, the speech recognition result obtained by the server 200 must be sent to the terminal 100 via the communication controllers 201 and 107.

Note that the process switch 103 of the terminal 100 switches connection to supply data to the speech communication information generator 104 upon initial setup, and to the encoder 106 upon speech recognition. Likewise, the process switch 202 of the server 200 switches connection to supply data to the speech communication information holding unit 203 upon initial setup, and to the decoder 204 upon speech recognition. These process switches 103 and 202 operate in cooperation with each other. Switching of these switches is done as follows. For example, two different modes, i.e., an initial learning mode and recognition mode, are prepared, and when the user designates the initial learning mode to learn before use of recognition, the process switch 103 switches connection to supply data to the speech communication information generator 104, and the process switch 202 switches connection to supply data to the speech communication information holding unit 203. Upon making recognition in practice, since the user designates the recognition mode, the process switch 103 switches connection to supply data to the encoder 106, and the process switch 202 switches connection to supply data to the decoder 204 in response to that user's designation.

Note that reference numeral 300 denotes a communication line which connects the terminal 100 and server 200, and various wired and wireless communication means can be used as long as they can transfer data.

Note that the respective units of the aforementioned terminal 100 and server 200 are implemented when their CPUs execute control programs stored in memories. Of course, some or all of the units may be implemented by hardware.

The operation in the speech recognition system will be described in detail below with reference to the flow charts of FIGS. 2 and 3.

Before the beginning of speech recognition, an initial setup shown in the flow chart of FIG. 2 is executed. In the initial setup, an encoding condition for adapting encoded data to an acoustic environment is set. If this initial setup process is skipped, it is possible to execute encoding and speech recognition of speech data using prescribed values generated based on an acoustic state in, e.g., a silent environment. However, by executing the initial setup process, the recognition rate can be improved.

In the initial setup process, the speech input unit 101 captures acoustic data and A/D-converts the captured acoustic data in step S2. The acoustic data to be input is that obtained when an utterance is made in an audio environment used in practice or a similar audio environment. This acoustic data also reflects the influence of the characteristics of a microphone used. If background noise or noise generated inside the device is present, the acoustic data is also influenced by such noise.

In step S3, the acoustic processor 102 executes acoustic analysis of the acoustic data input by the speech input unit 101. As described above, acoustic analysis can use analysis methods normally used in speech recognition such as melcepstrum, delta-melcepstrum, and the like. As described above, since the process switch 103 connects the speech communication information generator 104 in the initial setup process, the speech communication information generator 104 generates data for an encoding process in step S4.

The data generation method used in the speech communication information generator 104 will be explained below. As for encoding for speech recognition, a method of calculating acoustic parameters, and encoding these parameters by scalar quantization, vector quantization, or subband quantization may be used. In this embodiment, the method used need not be particularly limited, and any method can be used. In this case, a method using scalar quantization will be explained below. In this method, the respective dimensions of the multi-dimensional acoustic parameters obtained by acoustic analysis in step S3 undergo scalar quantization. Upon scalar quantization, various methods are available.

Two examples will be explained below.

1) Method based on LBG:

An LBG method, which is used normally, is used as a clustering method. Data of each dimension of the acoustic parameters are segmented into arbitrary classes (e.g., 16 steps) using the LBG method.

2) Method of assuming model:

Assume that data of the respective dimensions of the acoustic parameters follow, e.g., a Gaussian distribution. A 3σ (range of the entire distribution of each dimension is segmented into, e.g., 16 steps by clustering to have equal areas, i.e., equal probabilities.

Furthermore, the clustering result table obtained by the speech communication information generator 104 is transferred to the server 200 in step S6. Upon transfer, the communication controller 107 of the terminal 100, the communication line, and the communication controller 201 of the server 200 are used, and the clustering result table is transferred to the server.

In the server 200, the communication controller 201 receives the clustering result table in step S7. At this time, the process switch 202 connects the speech communication information holding unit 203 and communication controller 201, and the received clustering result table is recorded in the speech communication information holding unit 203 in step S8.

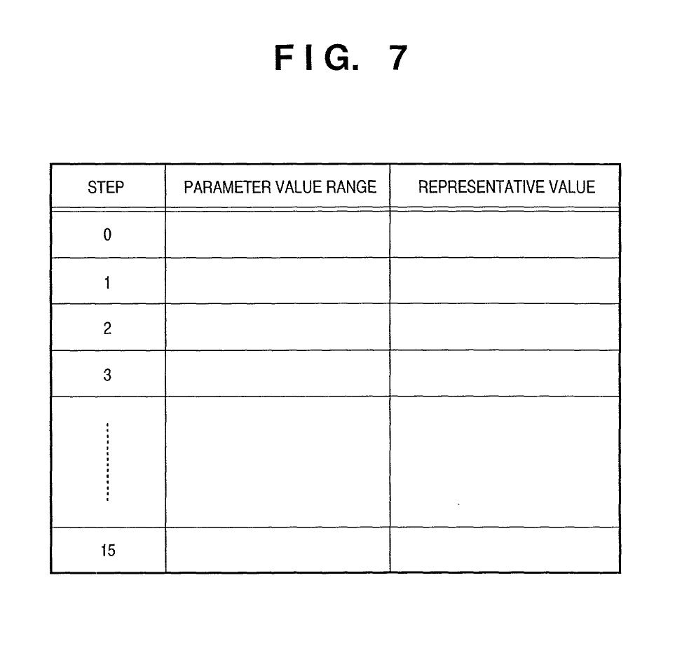

FIG. 7 is a view for explaining the clustering result table. In FIG. 7, clustering to 16 steps is done. A table for encoding shown in FIG. 7 is generated by the aforementioned method (e.g., the LBG method or the like) based on the acoustic parameters input in the initial learning mode. The table shown in FIG. 7 is generated for each dimension of the acoustic parameters, and registers step numbers and parameter value ranges of each dimension in correspondence with each other. By looking up this correspondence between the parameter value ranges and step numbers, the acoustic parameters are encoded using the step numbers. Each step number stores a representative value to be looked up in a decoding process. Note that the speech communication information holding unit 105 may store the step numbers and parameter value ranges, and the speech communication information holding unit 203 may store the step numbers and representative values. In this case, speech communication information sent from the terminal 100 to the server 200 may contain only the correspondence between the step numbers and parameter representative values.

Or the speech communication information generator 104 may generate correspondence between the step numbers and parameter range values, and correspondence between the step numbers and representative values used in the decoding process may be generated by the server 200 (speech communication information holding unit 203).

The process upon speech recognition will be explained below. FIG. 3 is a flow chart showing the flow of the process upon speech recognition.

In speech recognition, the speech input unit 101 captures speech to be recognized, and A/D converts the captured speech data in step S21. In step S22, the acoustic processor 102 executes acoustic analysis. Acoustic analysis can use analysis methods normally used in speech recognition such as melcepstrum, delta-melcepstrum, and the like. In the speech recognition process, the process switch 103 connects the acoustic processor 102 and encoder 106. Hence, the encoder 106 encodes the multi-dimensional feature quantity parameters obtained in step S22 using the clustering result table recorded in the speech communication information holding unit 105 in step S23. That is, the encoder 106 executes scalar quantization for respective dimensions.

Upon encoding, data of each dimension are converted into 4-bit (16-step) data by looking up the clustering result table shown in, e.g., FIG. 7. For example, when the number of dimensions of the parameters is 13, data of each dimension consists of 4 bits, and the analysis cycle is 10 ms, i.e., data are transferred at 100 frames/sec, the data size is:

13(dimensions)×4(bits)×100(frames/s)=5.2 kbps

In steps S24 and S25, the encoded data is output and received. Upon data transfer, the communication controller 107 of the terminal 100, the communication line, and the communication controller 201 of the server 200 are used, as described above. The communication line 300 can use various wired and wireless communication means as long as they can transfer data.

In the speech recognition process, the process switch 202 connects the communication controller 201 and decoder 204. Hence, the decoder 204 decodes the multi-dimensional feature quantity parameters received by the communication controller 201 using the clustering result table recorded in the speech communication information holding unit 203 in step S26. That is, the respective step numbers are converted into acoustic parameter values (representative values in FIG. 7). As a result of decoding, acoustic parameters are obtained. In step S27, speech recognition is done using the parameters decoded in step S26. This speech recognition is done by the speech recognition unit 205 using an acoustic model held in the acoustic model holding unit 206. Unlike normal speech recognition, no acoustic processor is used. This is because data decoded by the decoder 204 are the acoustic parameters. As an acoustic model, for example, an HMM (Hidden Markov Model) is used. In step S28, the application 207 runs using the speech recognition result obtained by speech recognition in step S27. The application 207 maybe installed in either the server 200 or terminal 100, or may be distributed to both the server 200 and terminal 100. When the application 207 runs on the terminal 100 or is distributed, the recognition result, the internal status data of the application, and the like must be transferred using the communication controllers 107 and 201 and the communication line 300.

As described above, according to the first embodiment, the clustering result table adapted to the acoustic state at that time is generated in the initial learning mode, and encoding/decoding is done based on this clustering result table upon speech recognition. Since encoding/decoding is done using the table (clustering result table) adapted to the acoustic state, appropriate encoding can be attained in correspondence with a change in acoustic feature. For this reason, a recognition rate drop due to a change in environment noise can be prevented.

<Second Embodiment>

In the first embodiment, the encoding condition (clustering result table) adapted to the acoustic state is generated, and an encoding/decoding process is executed by sharing this encoding condition between the encoder 106 and decoder 204, thus realizing transmission of appropriate speech data, and a speech recognition process. In the second embodiment, a method of recognizing encoded data without decoding it to attain higher processing speed will be explained.

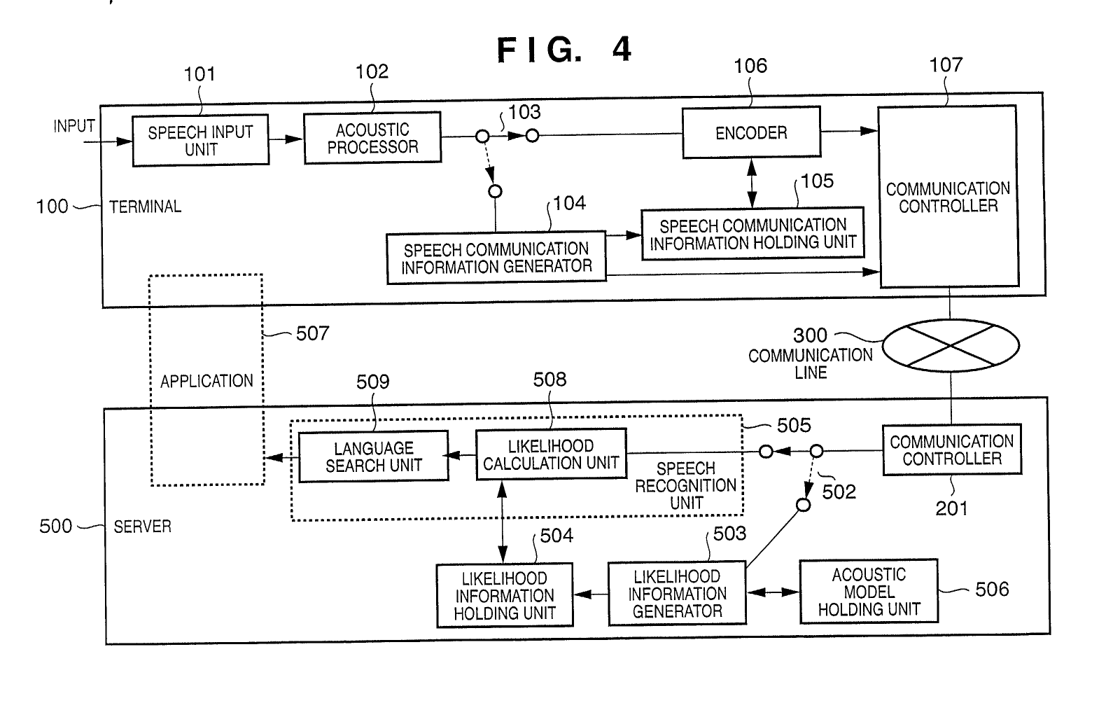

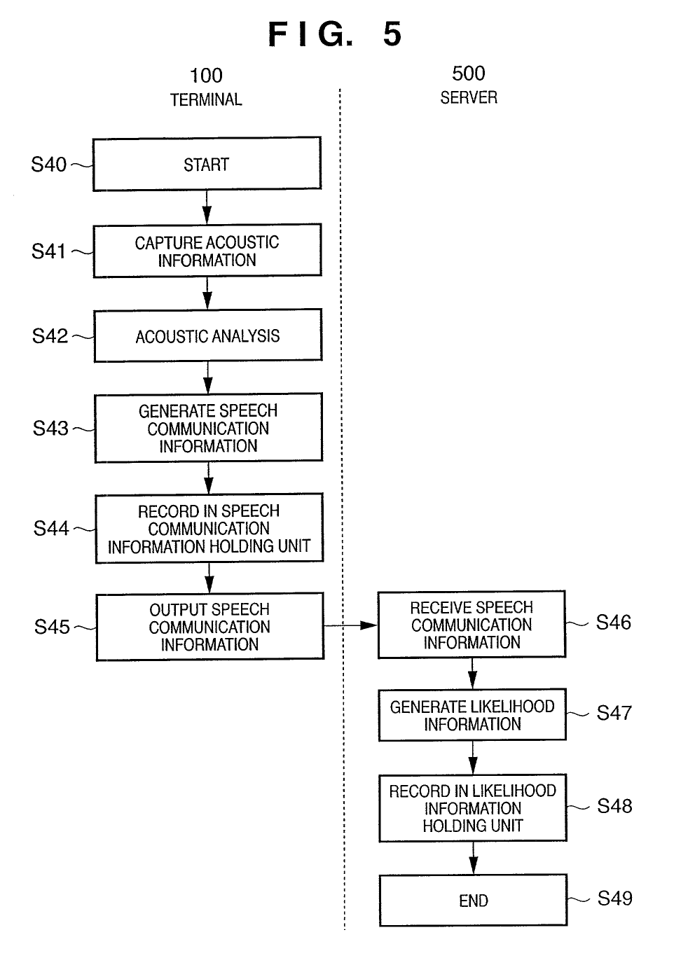

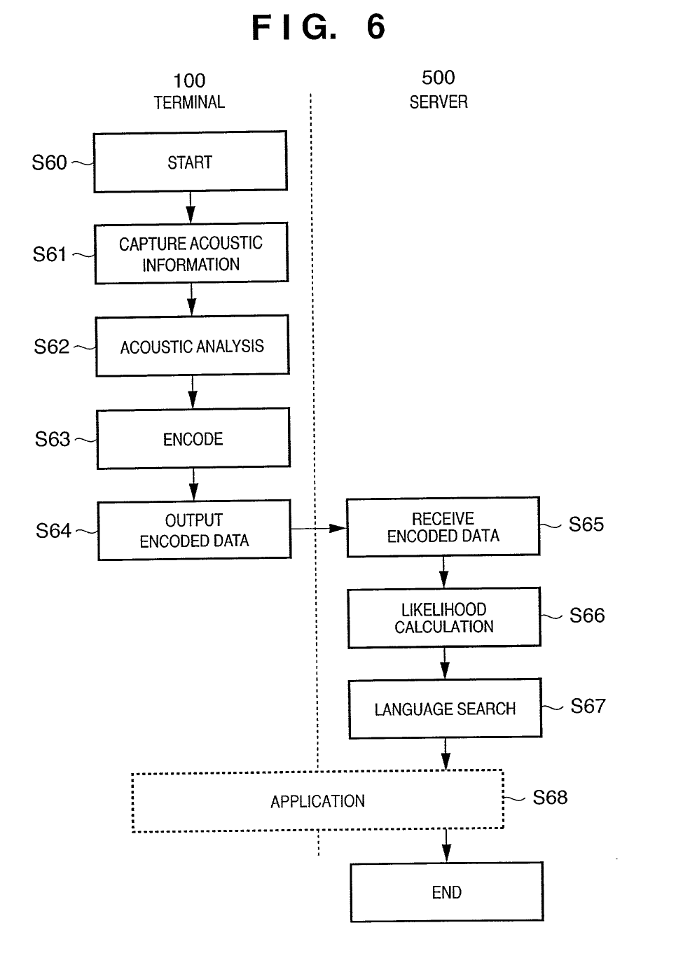

FIG. 4 is a block diagram showing the arrangement of a speech recognition system according to the second embodiment. FIGS. 5 and 6 are flow charts for explaining the operation of the speech recognition system shown in the diagram of FIG. 4. The second embodiment will be explained below as well as its operation example while associating FIG. 4 with FIGS. 5 and 6.

The same reference numerals in FIG. 4 denote the same parts as in the arrangement of the first embodiment. As can be seen from FIG. 4, the terminal 100 has the same arrangement as in the first embodiment. On the other hand, in a server 500, a process switch 502 connects the communication controller 201 and a likelihood information generator 503 in an initial setup process, and connects the communication controller 201 and a speech recognition unit 505 in a speech recognition process.

Reference numeral 503 denotes a likelihood information generator for generating likelihood information on the basis of the input clustering result table, and an acoustic model held in an acoustic model holding unit 506. The likelihood information generated by the generator 503 allows speech recognition without decoding the encoded data. The likelihood information and its generation method will be described later. Reference numeral 504 denotes a likelihood information holding unit for holding the likelihood information generated by the likelihood information generator 503. Note that various recording media such as a memory (e.g., a RAM), floppy disk (FD), hard disk (HD), and the like can be used to hold the likelihood information in the likelihood information holding unit 504.

Reference numeral 505 denotes a speech recognition unit, which comprises a likelihood calculation unit 508 and language search unit 509. The speech recognition unit 505 executes a speech recognition process of the encoded data input via the communication controller 201 using the likelihood information held in the likelihood information holding unit 504, as will be described later.

The speech recognition process of the second embodiment will be described below with reference to FIGS. 5 and 6.

An initial setup process is done before the beginning of speech recognition. As in the first embodiment, the initial setup process is executed to adapt encoded data to an acoustic environment. If this initial setup process is skipped, it is possible to execute encoding and speech recognition of speech data using prescribed values in association with encoded data. However, by executing the initial setup process, the recognition rate can be improved.

Respective processes in steps S40 to S45 in the terminal 100 are the same as those in the first embodiment (steps S1 to S6), and a description thereof will be omitted. The initial setup process of the server 500 will be explained below.

In step S46, the communication controller 201 receives speech communication information (clustering result table in this embodiment) generated by the terminal 100. The process switch 502 connects the likelihood information generator 503 in the initial step process. Hence, likelihood information is generated in step S47. Generation of the likelihood information will be explained below. The likelihood information is generated by the likelihood information generator 503 using an acoustic model held in the acoustic model holding unit 506. This acoustic model is expressed by, e.g., an HMM.

Various likelihood information generation methods are available. In this embodiment, a method using scalar quantization will be explained. As described in the first embodiment, a clustering result table for scalar quantization is obtained for each dimension of the multi-dimensional acoustic parameter by the process of the terminal 100 in steps S40 to S45. Some steps of likelihood calculations are made for respective quantization points using the values of respective quantization points held in this table and the acoustic model. This value is held in the likelihood information holding unit 504. In the recognition process, since the likelihood calculations are made by table lookup on the basis of scalar quantization values received as encoded data, the need for decoding can be obviated.

For further details of such likelihood calculation method by table lookup, refer to Sagayama et. al., “New High-speed Implementation in Speech Recognition”, Proc. of ASJ Spring Meeting 1-5-12, 1995. Other vector quantization methods of scalar quantization, a method of omitting additions by making mixed distribution operations of respective dimensions in advance, and the like may be used. These methods are also introduced in the above reference. The calculation result is held in the likelihood information holding unit 504 in the form of a table for scalar quantization values in step S48.

The flow of the speech recognition process according to the second embodiment will be described below with reference to FIG. 6. Respective processes in steps S60 to S64 in the terminal 100 are the same as those in the first embodiment (steps S20 to S24), and a description thereof will be omitted.

In step S65, the communication controller 201 of the server 500 receives encoded data of the multi-dimensional acoustic parameters obtained by the processes in steps S20 to S24. In the speech recognition process, the process switch 502 connects the likelihood calculation unit 508. The speech recognition unit 505 can be separately expressed by likelihood calculation unit 508 and language search unit 509. In step S66, the likelihood calculation unit 508 calculates likelihood information. In this case, the likelihood information is calculated by table lookup for scalar quantization values using the data held in the likelihood information holding unit 504 in place of the acoustic model. Since details of the calculations are described in the above reference, a description thereof will be omitted.

In step S67, the likelihood calculation result in step S66 undergoes a language search to obtain a recognition result. The language search is made using a word dictionary, and a grammar which is normally used in speech recognition such as a network grammar, language model such as n-gram, and the like. In step S68, an application 507 runs using the obtained recognition result. As in the first embodiment, the application 507 may be installed in either the server 500 or terminal 100, or may be distributed to both the server 500 and terminal 100. When the application 507 runs on the terminal 100 or is distributed, the recognition result, the internal status data of the application, and the like must be transferred using the communication controllers 107 and 201 and the communication line 300.

As described above, according to the second embodiment, since speech recognition can be done without decoding the encoded data, high-speed processing can be achieved.

The speech recognition process of the first and second embodiments described above can be used for applications that utilize speech recognition. Especially, the above speech recognition process is suitable for a case wherein a compact portable terminal is used as the terminal 100, and device control and information search are made by means of speech input.

According to the above embodiments, when the speech recognition process is distributed and executed on different devices using encoding for speech recognition, an encoding process is done in accordance with background noise, internal noise, the characteristics of a microphone, and the like. For this reason, even in a noisy environment, or even when a microphone having different characteristics is used, a recognition rate drop can be prevented, and efficient encoding can be implemented, thus obtaining merits (e.g., the transfer data size on a communication path can be suppressed).

Note that the objects of the present invention are also achieved by supplying a storage medium, which records a program code of a software program that can implement the functions of the above-mentioned embodiments to the system or apparatus, and reading out and executing the program code stored in the storage medium by a computer (or a CPU or MPU) of the system or apparatus.

In this case, the program code itself read out from the storage medium implements the functions of the above-mentioned embodiments, and the storage medium which stores the program code constitutes the present invention.

As the storage medium for supplying the program code, for example, a floppy disk, hard disk, optical disk, magneto-optical disk, CD-ROM, CD-R, magnetic tape, nonvolatile memory card, ROM, and the like may be used.

The functions of the above-mentioned embodiments may be implemented not only by executing the readout program code by the computer but also by some or all of actual processing operations executed by an OS (operating system) running on the computer on the basis of an instruction of the program code.

Furthermore, the functions of the above-mentioned embodiments may be implemented by some or all of actual processing operations executed by a CPU or the like arranged in a function extension board or a function extension unit, which is inserted in or connected to the computer, after the program code read out from the storage medium is written in a memory of the extension board or unit.

To restate, according to the present invention, appropriate encoding can be made in correspondence with a change in acoustic feature, and the recognition rate and compression ratio upon encoding can be prevented from lowering due to a change in environmental noise.

As many apparently widely different embodiments of the present invention can be made without departing from the spirit and scope thereof, it is to be understood that the invention is not limited to the specific embodiments thereof except as defined in the claims.

What is claimed is:

1. A speech recognition system comprising:
input means for inputting acoustic information;
analysis means for analyzing the acoustic information input by said input means to acquire feature quantity parameters;
first holding means for obtaining and holding processing information for encoding on the basis of the feature quantity parameters obtained by said analysis means;
second holding means for holding processing information for a speech recognition process in accordance with the processing information for encoding;
conversion means for compression-encoding the feature quantity parameters obtained via said input means and said analysis means on the basis of the processing information for encoding; and
recognition means for executing speech recognition on the basis of the processing information for speech recognition held by said holding means, and the feature quantity parameters compression-encoded by said conversion means.

2. The system according to claim 1, wherein said system is built by a first apparatus having said analysis means, said first holding means, and said conversion means, and a second apparatus having said recognition means, and
said system further comprises communication means for sending the processing information generated by said first holding means and data acquired by said conversion means from the first apparatus to the second apparatus.

3. The system according to claim 1, wherein said second holding means holds processing information used to decode information converted by said conversion means, and
said recognition means comprises:
decoding means for decoding the compression-encoded feature quantity parameters by looking up the processing information held in said second holding means, and
said recognition means executes a speech recognition process on the basis of the feature quantity parameters decoded by said decoding means.

4. The system according to claim 2, wherein said second holding means is arranged in the second apparatus.

5. The system according to claim 1, wherein said second holding means makes some steps of a likelihood calculation associated with speech recognition on the basis of the processing information for encoding and an acoustic model, and holds the calculation result as the information for speech recognition, and
said recognition means obtains a speech recognition result by making a likelihood calculation for data acquired by said conversion means using the information held by said second holding means.

6. The system according to claim 1, further comprising mode designation means for selectively executing a learning mode of making said first and second holding means function, and a speech recognition mode of making said conversion means and said recognition means function.

7. The system according to claim 1, wherein said conversion means scalar-quantizes multi-dimensional speech parameters obtained by said analysis means for respective dimensions.

8. The system according to claim 7, wherein the scalar quantization uses an LBG algorithm.

9. The system according to claim 7, wherein the scalar quantization assumes that data to be quantized form a Gaussian distribution, and quantizes with quantization steps having equal probabilities in the distribution.

10. The system according to claim 7, wherein setting means changes clustering for the scalar quantization on the basis of the feature quantity parameters obtained by said analysis means.

11. A speech recognition method comprising:
the input step of inputting acoustic information;
the analysis step of analyzing the acoustic information input in the input step to acquire feature quantity parameters;
the first holding step of obtaining processing information for encoding on the basis of the feature quantity parameters obtained in the analysis step, and storing the information in first storage means;
the second holding step of holding, in second storage means, processing information for a speech recognition process in accordance with the processing information for encoding;
the conversion step of compression-encoding the feature quantity parameters obtained via the input step and the analysis step on the basis of the processing information for encoding; and
the recognition step of executing speech recognition on the basis of the processing information for speech recognition held in said second storage means in the second holding step, and the feature quantity parameters compression-encoded in the conversion step.

12. The method according to claim 11, wherein a system is built by a first apparatus which executes the analysis step, the first holding step, and the conversion step, and a second apparatus which executes the recognition step, and
said method further comprises the communication step of sending the processing information generated in the first holding step and data acquired in the conversion step from the first apparatus to the second apparatus.

13. The method according to claim 11, wherein the second holding step includes the step of holding, in said second storage means, processing information used to decode information converted in the conversion step, and
the recognition step comprises:
the decoding step of decoding the compression-encoded feature quantity parameters by looking up the processing information held in said second storage means, and
the recognition step includes the step of executing a speech recognition process on the basis of the feature quantity parameters decoded in the decoding step.

14. The method according to claim 12, wherein the second holding step is executed by the second apparatus.

15. The method according to claim 11, wherein the second holding step includes the step of making some steps of a likelihood calculation associated with speech recognition on the basis of the processing information for encoding and an acoustic model, and holding the calculation result as the information for speech recognition, and
the recognition step includes the step of obtaining a speech recognition result by making a likelihood calculation for data acquired in the conversion step using the information held in the second holding step.

16. The method according to claim 11, further comprising the mode designation step of selectively executing a learning mode of making the first and second holding steps function, and the speech recognition mode of making the conversion step and the recognition step function.

17. The method according to claim 11, wherein the conversion step includes the step of scalar-quantizing multi-dimensional speech parameters obtained in the analysis step for respective dimensions.

18. The method according to claim 17, wherein the scalar quantization uses an LBG algorithm.

19. The method according to claim 17, wherein the scalar quantization assumes that data to be quantized form a Gaussian distribution, and quantizes with quantization steps having equal probabilities in the distribution.

20. The method according to claim 17, wherein the setting step includes the step of changing clustering for the scalar quantization on the basis of the feature quantity parameters obtained by the analysis step.

21. An information processing apparatus comprising:
input means for inputting acoustic information;
analysis means for analyzing the acoustic information input by said input means to acquire feature quantity parameters;
holding means for generating and holding processing information for compression-encoding on the basis of the feature quantity parameters obtained by said analysis means;
first communication means for sending the processing information generated by said holding means to an external apparatus;
conversion means for compression-encoding the feature quantity parameters of the acoustic information obtained via said input means and said analysis means on the basis of the processing information; and
second communication means for sending data obtained by said conversion means to the external apparatus.

22. An information processing apparatus comprising:
first reception means for receiving processing information associated with compression-encoding from an external apparatus;
holding means for holding, in a memory, processing information for speech recognition obtained on the basis of the processing information received by said first reception means;
second reception means for receiving compression-encoded data from the external apparatus; and
recognition means for executing speech recognition of the data received by said second reception means using the processing information held in said holding means.

23. The apparatus according to claim 21, wherein said recognition means comprises:
decoding means for decoding data received by said second reception means using the processing information held in said holding means; and
means for executing a speech recognition process on the basis of feature quantity data decoded by said decoding means.

24. The apparatus according to claim 21, wherein said holding means generates likelihood information on the basis of the processing information received by said first reception means, and a predetermined acoustic model, and holds the likelihood information in the memory, and
said recognition means makes speech recognition by making a likelihood calculation on the basis of data received by said second reception means using the likelihood information held in the memory.

25. An information processing method comprising:
the input step of inputting acoustic information;
the analysis step of analyzing the acoustic information input in the input step to acquire feature quantity parameters;
the holding step of generating and holding processing information for compression-encoding on the basis of the feature quantity parameters obtained in the analysis step;
the first communication step of sending the processing information generated in the holding step to an external apparatus;
the conversion step of compression-encoding the feature quantity parameters of the acoustic information obtained via the input step and the analysis step on the basis of the processing information; and
the second communication step of sending data obtained in the conversion step to the external apparatus.

26. An information processing method comprising:
the first reception step of receiving processing information associated with compression-encoding from an external method;
the holding step of holding, in a memory, processing information for speech recognition obtained on the basis of the processing information received in the first reception step;
the second reception step of receiving compression-encoded data from the external method; and
the recognition step of executing speech recognition of the data received in the second reception step using the processing information held in the holding step.

27. The method according to claim 26, wherein the recognition step comprises:
the decoding step of decoding data received in the second reception step using the processing information held in the holding step; and
the step of executing a speech recognition process on the basis of feature quantity data decoded in the decoding step.

28. The method according to claim 26, wherein the holding step includes the step of generating likelihood information on the basis of the processing information received in the first reception step, and a predetermined acoustic model, and holding the likelihood information in the memory, and
the recognition step includes the step of making speech recognition by making a likelihood calculation on the basis of data received in the second reception step using the likelihood information held in the memory.

29. A computer readable medium for storing a control program for making a computer execute a speech recognition process, said speech recognition process comprising:
the input step of inputting acoustic information;
the analysis step of analyzing the acoustic information input in the input step to acquire feature quantity parameters;
the first holding step of obtaining processing information for encoding on the basis of the feature quantity parameters obtained in the analysis step, and storing the information in first storage means;
the second holding step of holding, in second storage means, processing information for a speech recognition process in accordance with the processing information for encoding;
the conversion step of compression-encoding the feature quantity parameters obtained via the input step and the analysis step on the basis of the processing information for encoding; and
the recognition step of executing speech recognition on the basis of the processing information for speech recognition held in said second storage means in the holding step, and the feature quantity parameters
compression-encoded in the conversion step.

30. A computer readable medium for storing a control program for making a computer execute a predetermined information process, said predetermined information process comprising:
the input step of inputting acoustic information;
the analysis step of analyzing the acoustic information input in the input step to acquire feature quantity parameters;
the holding step of generating and holding processing information for compression-encoding on the basis of the feature quantity parameters obtained in the analysis step;
the first communication step of sending the processing information generated in the holding step to an external apparatus;
the conversion step of compression-encoding the feature quantity parameters of the acoustic information obtained via the input step and the analysis step on the basis of the processing information; and
the second communication step of sending data obtained in the conversion step to the external method.

31. A computer readable medium for storing a control program for making a computer execute a speech recognition process, said speech recognition process comprising:
the first reception step of receiving processing information associated with compression-encoding from an external method;
the holding step of holding, in a memory, processing information for speech recognition obtained on the basis of the processing information received in the first reception step;
the second reception step of receiving compression-encoded data from the external apparatus; and
the recognition step of executing speech recognition of the data received in the second reception step using the processing information held in the holding step.
